(19) United States
(12) Patent Application Publication
(10) Pub. No.: US 2020/0227067 A1
(43) Pub. Date: Jul. 16, 2020

(54) COMMUNICATION AID SYSTEM

(71) Applicant: Hsiao-Han CHEN, Tainan City (TW)

(72) Inventor: Hsiao-Han CHEN, Tainan City (TW)

(21) Appl. No.: 16/738,701

(22) Filed: Jan. 9, 2020

(30) Foreign Application Priority Data
Jan. 11, 2019 (TW) 108200532

(51) Int. Cl. G10L 21/10; G10L 25/78; G10L 15/22; G10L 15/26; H04R 1/40; H04R 3/00

(52) U.S. Cl. CPC G10L 21/10; G10L 25/78; G10L 15/22; G10L 2021/065; H04R 1/406; H04R 3/005; G10L 15/265

(57) ABSTRACT

A communication aid system includes a sound receiving device and a display device. The sound receiving device includes multiple microphones and a controller. When in a sound receiving mode, the controller controls a corresponding subset of the microphones to receive sound to generate one or more collected audio signals, and performs corresponding audio signal processing on the collected audio signal (s) to generate a processed audio signal. The display device includes an audio-to-visual converter and a display. The audio-to-visual converter receives the processed audio signal, recognizes speech information contained therein, and converts the speech information into visual information to be displayed by the display.

### CROSS-REFERENCE TO RELATED APPLICATION

This application claims priority of Taiwanese Utility Model Patent Application No. 108200532, filed on Jan. 11, 2019.

### FIELD

The disclosure relates to a communication aid system, and more particularly to a communication aid system for assisting a hearing-impaired user.

### BACKGROUND

A conventional approach to improving listening comprehension of a hearing-impaired individual with severe hearing loss (i.e., hearing loss of 60 to 90 decibels) utilizes techniques of frequency shifting or frequency transposition to process sound by shifting frequencies of sound from an inaudible range to an audible range of the hearing-impaired individual. However, because of the unnatural voice quality of processed sound generated by such approach, the hearing-impaired individual usually has to spend a lot of time familiarize himself or herself to the processed sound.

Another conventional approach to aiding hearing-impaired individuals with severe hearing loss is artificial cochlea implant (CI). Bypassing the normal acoustic hearing process of a human, artificial CI converts sound into electric signals, and directly applies the electric signals to stimulate functional auditory nerves of the hearing-impaired individuals. However, sensory perception of the stimulation provided by artificial CI is different from that of the normal acoustic hearing process, so extended auditory training for interpreting the electric stimulation made by artificial CI is required for hearing-impaired individuals with artificial CI. In this sense, artificial CI may be unsuitable for adults who have well-developed language abilities.

### SUMMARY

Therefore, an object of the disclosure is to provide a communication aid system for a hearing-impaired user that can alleviate at least one of the drawbacks of the prior art.

According to the disclosure, the communication aid system includes a sound receiving device and a display device.

The sound receiving device includes a plurality of microphones that are spaced apart from each other, and a sound receiving controller that is communicably connected with the microphones.

The sound receiving controller is switchable among a plurality of sound receiving modes, and is configured to, for each of the sound receiving modes, when the sound receiving controller is in the sound receiving mode, control a corresponding subset of the microphones to receive sound to generate one or more collected audio signals, and perform audio signal processing specific to the sound receiving mode on the collected audio signal (s) so as to generate a corresponding processed audio signal.

The display device is communicably connected with the sound receiving device, and includes an audio-to-visual converter and a display. The audio-to-visual converter is configured to receive the processed audio signal, and to perform speech recognition on the processed audio signal to recognize speech information contained in the processed audio signal, and convert the speech information thus recognized into visual information. The display is communicably connected with the audio-to-visual converter, and is configured to display the visual information.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a communication aid system according to the disclosure;

FIG. 2 is a block diagram illustrating the embodiment of the communication aid system according to the disclosure;

FIG. 3 is a perspective schematic diagram illustrating an example of putting the communication aid system according to the disclosure into use;

FIG. 4 is a schematic diagram illustrating an embodiment of display of a field of view (FOV) image by the communication aid system according to the disclosure; and

FIG. 5 is a perspective view illustrating another embodiment of the communication aid system according to the disclosure.

### DETAILED DESCRIPTION

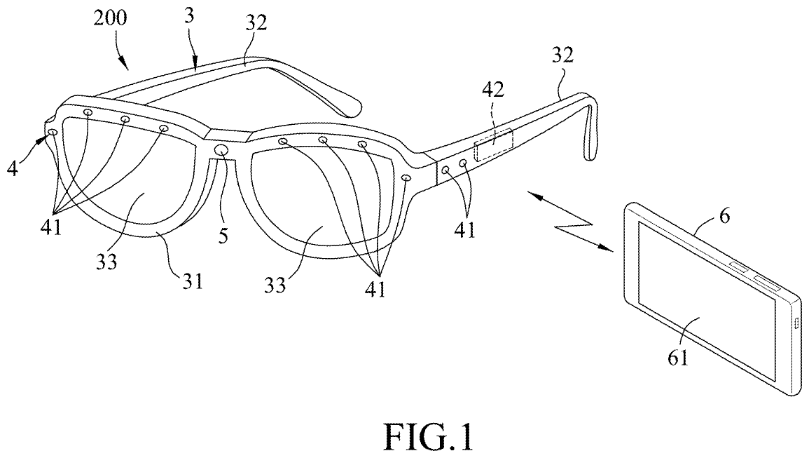

Referring to FIGS. 1 to 3, an embodiment of a communication aid system 200 according to the disclosure for assisting a hearing-impaired user 900 is illustrated. The communication aid system 200 is adapted to be worn on the hearing-impaired user 900, and to assist in listening comprehension of the hearing-impaired user 900.

The communication aid system 200 includes a carrier 3, a display device 6, and a sound receiving device 4 and an image capturing device 5 that are mounted on the carrier 3 and that are communicably connected with each other.

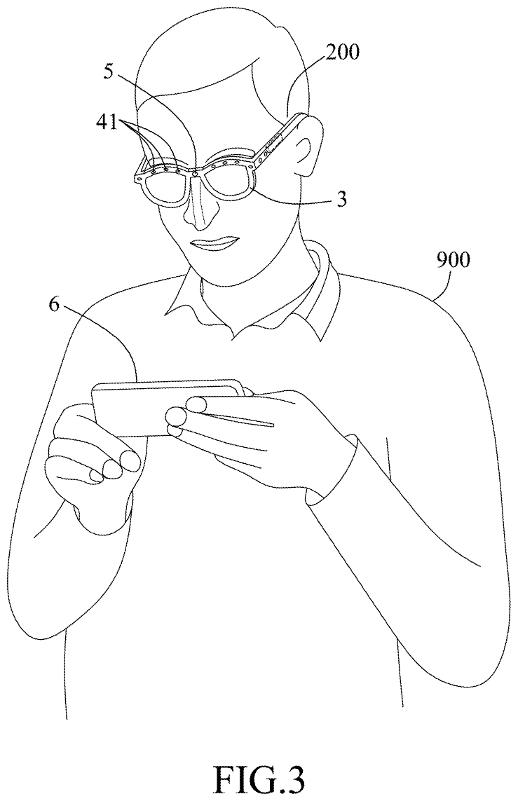

As shown in FIGS. 1 and 3, in this embodiment, the carrier 3 is a pair of glasses, and is adapted to be worn on the head of the hearing-impaired user 900. The carrier 3 has two lenses 33 to be positioned in front of the eyes of the hearing-impaired user 900. The carrier 3 further has a frame front 31, and left and right frame sides 32 (i.e., left and right temples for the pair of glasses) that are respectively engaged to two opposite sides of the frame front 31 and that are adapted to be mounted on respective ears of the hearing-impaired user 900. The image capturing device 5 is mounted on a middle segment of the frame front 31, and is configured to capture a field of view (FOV) image which is an image of surroundings seen by the hearing-impaired user 900.

The sound receiving device 4 includes a plurality of microphones 41 and a sound receiving controller 42. The microphones 41 are longitudinally arranged on the frame front 31 and left and right frame sides 32 of the carrier 3, are spaced apart from each other, and are respectively disposed at predefined positions on the carrier 3. The sound receiving controller 42 is communicably connected with the microphones 41.

The sound receiving controller 42 is switchable among a plurality of sound receiving modes. For each of the sound receiving modes, when the sound receiving controller 42 is in the sound receiving mode, the sound receiving controller 42 is configured to control a corresponding specific subset of the microphones 41 to receive sound to generate a collected audio signal. The corresponding specific subset of the microphones 41 is composed of those (one or more) of the microphones 41 that are located at preset positions designated or required by the sound receiving mode, and a total number of microphones 41 contained in the subset and the preset positions of these microphones 41 are decided in advance to satisfy the specific design concept of the sound receiving mode. For each of the sound receiving modes, the sound receiving controller 42 is configured to perform corresponding audio signal processing on the collected audio signal (s) so as to generate a processed audio signal corresponding to the collected audio signal (s).

Specifically speaking, the sound receiving controller 42 includes a microphone control module 421 and a speech detecting module 422. In this embodiment, the microphone control module 421 of the sound receiving controller 42, in particular, is switch able among the sound receiving modes which include an omnidirectional mode and a plurality of directional modes. The directional modes respectively correspond to different values of directivity index (DI). For each of the directional modes, the microphone control module 421 controls specific two of the microphones 41 corresponding to the directional mode to receive sound to generate collected audio signals, and a function of receiving directional sound may thus be achieved.

In this embodiment, the microphone control module 421 operates in the omnidirectional mode by default at the start of using the communication aid system 200. When the microphone control module 421 is in the omnidirectional mode, the microphone control module 421 controls a predefined one of the microphones 41 to receive sound to generate a corresponding collected audio signal and performs audio signal processing specific to the omnidirectional mode on the collected audio signal to generate a processed audio signal corresponding to the collected audio signal. In this embodiment, the audio signal processing specific to the omnidirectional mode includes analog-to-digital conversion and/or noise reduction processing, but is not limited to the disclosure herein and may vary in other embodiments. For the omnidirectional mode, the audio signal processing is performed on the collected audio signal in order to filter out noise from the collected audio signal so as to enhance the signal-to-noise ratio of the processed audio signal.

When the microphone control module 421 operates in the omnidirectional mode and has generated the processed audio signal corresponding to the collected audio signal generated in the omnidirectional mode, the speech detecting module 422 is configured to determine whether such processed audio signal contains speech information. When it is determined that the processed audio signal contains speech information, the speech detecting module 422 is configured to control the microphone control module 421 to switch to the directional modes one by one (to operate in one of the directional modes, then switch to another one of the directional modes, and so on) in order to obtain various collected audio signals for the different directional modes (the audio signal processing on the collected audio signals is not performed at this stage) and to eventually obtain a processed audio signal having optimum signal-to-noise ratio among processed audio signals that would be generated respectively in the directional modes. In detail, the sound receiving controller 42 is configured to determine a direction of source of the speech information and a direction of source of the noise by analyzing the collected audio signals obtained in the various directional modes. Based on the result of the analysis, the microphone control module 42 is controlled to operate in one of the directional modes that corresponds to a most suitable one of the values of DI such that sensitivity in the direction of source of the speech information is the highest while sensitivity in the direction of source of the noise is at a minimum. The microphone control module 421 then, while operating in said one of the directional modes, performs audio signal processing specific to the directional mode on the collected audio signals so as to generate the optimum processed audio signal. In this way, a processed audio signal having optimum signal-to-noise ratio may be obtained.

In this embodiment, for each of the directional modes, the audio signal processing specific thereto is related to speech extraction techniques, and includes analog-to-digital conversion, noise reduction processing, and/or signal amplification processing, but is not limited to the disclosure herein and may vary in other embodiments. For each of the directional modes, the audio signal processing is performed on the collected audio signals to filter out noise from the collected audio signals and to extract and amplify speech content in the collected audio signals so as to further enhance the signal-to-noise ratio of the resultant processed audio signal. Since implementations of the analog-to-digital conversion, the noise reduction processing and the signal amplification processing in the disclosure are well known to one skilled in the relevant art, detailed explanation of the same is omitted herein for the sake of brevity.

It is noted herein that the sound receiving controller 42 may be implemented by a processor, a central processing unit (CPU), a microprocessor, a micro control unit (MCU), or any circuit configurable/programmable in a software manner and/or hardware manner to implement functionalities discussed in this disclosure.

Each of the microphone control module 421 and the speech detecting module 422 may be implemented by one of hardware, firmware, software, and any combination thereof. For example, the microphone control module 421 and the speech detecting module 422 may be implemented to be software modules in a program, where the software modules contain codes and instructions to carry out specific functionalities, and can be called individually or together to fulfill the relevant functionalities discussed in this disclosure.

The display device 6 is communicably connected with the sound receiving device 4 based on wireless communication techniques. Since implementation of the wireless communication techniques has been well known to one skilled in the relevant art, detailed explanation of the same is omitted herein for the sake of brevity.

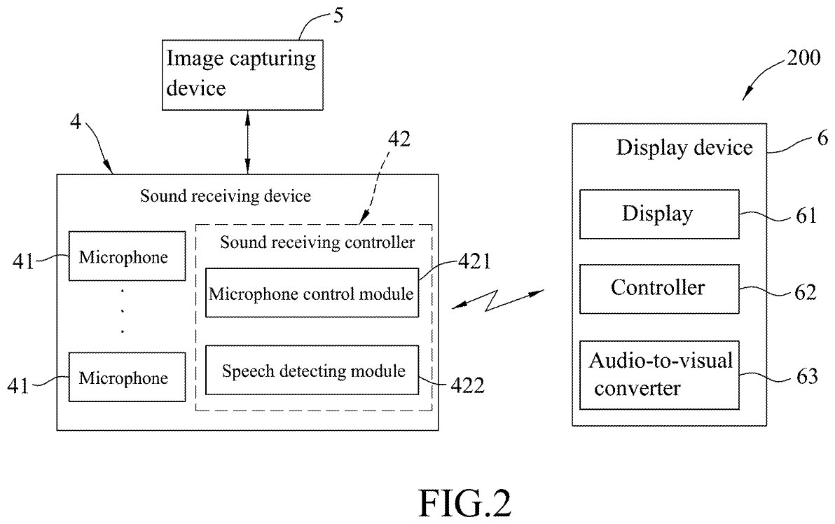

Referring to FIGS. 2, 3 and 4, the display device 6 may be implemented by a portable device such as a smartphone (see FIG. 3) or a tablet, or by a wearable device such as a smart wristband, a smart watch or a smart necklace. However, implementation of the display device 6 is not limited to the disclosure herein and may vary in other embodiments.

As shown in FIG. 2, the display device 6 includes a display 61, a controller 62, and an audio-to-visual converter 63 that communicably connected with the display 61.

The audio-to-visual converter 63 is configured to receive the processed audio signal generated by the sound receiving device 4, to perform speech recognition on the received processed audio signal so as to recognize the speech information contained in the processed audio signal and convert the speech information thus recognized into visual information. The visual information may be an image or text, but is not limited thereto and may vary in other embodiments. Since speech recognition techniques are well known in the art, details of the same are omitted herein for the sake of brevity.

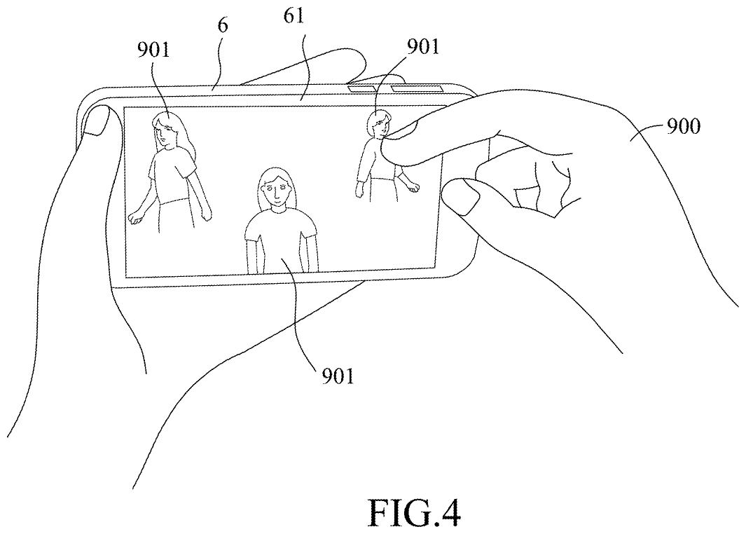

In this embodiment, the display 61 is a touchscreen, and is configured to display the visual information and the FOV image captured by the image capturing device 5. The controller 62 is operable to control the sound receiving device 4 to trigger the image capturing device 5 to capture the FOV image, and is operable to control the display 61 to display the FOV image in real time so as to allow selection operation by the hearing-impaired user 900. As shown in FIG. 4, the hearing-impaired user 900 may designate a location of an intended sound source 901, such as a speaker, in the surroundings by selecting an area (hereinafter also referred to as “selected area”) showing the intended sound source 901 in the FOV image displayed by the display 61 through tapping. The controller 62 generates a direction designation signal that indicates position of the selected area in the FOV image based on the user input of selecting the selected area, and outputs the direction designation signal to the sound receiving device 4.

It is worth to note that the sound receiving modes further include a direction designation mode. In response to receipt of the direction designation signal, the microphone control module 421 is switched to the direction designation mode, which is a mode that essentially homes in on the sound coming from the intended sound source 901. The microphone control module 421 is configured to, when in the direction designation mode, control a microphone array to receive sound to generate collected audio signals, wherein the microphone array is constituted by a predefined subset of the microphones 41 of the sound receiving device 4 so each of the microphones 41 in the microphone array is at a predefined position. After the collected audio signals are generated, the microphone control module 421 is configured to perform, based on the direction designation signal, filtering processing on the collected audio signals by using beamforming techniques so as to generate a filtered audio signal which corresponds to sound coming from a direction that is related to the position of the selected area in the FOV image indicated by the direction designation signal (i.e., the location of the intended sound source 901 in the surroundings), and is also configured to perform audio signal processing specific to the direction designation mode on the filtered audio signal so as to generate a corresponding processed audio signal. After receiving the processed audio signal generated by the sound receiving device 4, the audio-to-visual converter 63 performs speech recognition on the processed audio signal, and recognizes the speech information contained in the processed audio signal, and converts the speech information thus recognized into visual information (i.e., text or images) which is subsequently displayed by the display 61. With the visual information, the hearing-impaired user 900 is able to understand the spoken contents of the intended sound source 901. The audio signal processing specific to the direction designation mode is similar to that for the directional modes, so detailed explanation for the audio signal processing corresponding to the direction designation mode is omitted herein for the sake of brevity. In addition, beamforming techniques should be familiar to those skilled in the art, so relevant description on this topic is omitted.

To use the communication aid system 200, the hearing-impaired user 900 wears the carrier 3 on his/her head, and places the display device 6 within view (e.g., by holding the display device 6 in his/her hand). The sound receiving controller 42 of the sound receiving device 4 operates in the omnidirectional mode at first to control the predefined one of the microphones 41 to receive sound and generate a corresponding collected audio signal. When it is determined that the collected audio signal contains speech information, the sound receiving controller 42 adaptively switches to one of the directional modes to obtain a processed audio signal having the optimum signal-to-noise ratio among processed audio signals that would be generated in the directional modes. In receipt of the processed audio signal generated by the sound receiving device 4, the audio-to-visual converter 63 of the display device 6 performs speech recognition on the processed audio signal to recognize the speech information contained in the processed audio signal, and convert the speech information thus recognized into the visual information (i.e., text or images). Subsequently, the display 61 of the display device 6 displays the visual information for viewing by the hearing-impaired user 900.

Additionally, in order to focus on an intended sound source 901, the hearing-impaired user 900 may operate the display device 6 to select an area in the FOV image displayed on the display 61 that corresponds to the intended sound source 901, causing the controller 62 to generate a direction designation signal that indicates the position of the selected area in the FOV image based on the user input of selecting the selected area. In response to receipt of the direction designation signal, the sound receiving controller 42 switches to the direction designation mode, controls the microphone array, which is constituted by predefined two or more of the microphones 41, to receive sound to generate corresponding collected audio signals, performs, based on the position of the selected area in the FOV image indicated by the direction designation signal, the filtering processing on the collected audio signals by using the beamforming techniques to generate filtered audio signal, and performs the audio signal processing specific to the direction designation mode on the filtered audio signal to generate the processed audio signal, which is now more focused on sound coming from the intended sound source 901. The display device 6 receives the processed audio signal, recognizes the speech information contained therein, and converts the speech information thus recognized into visual information for visual presentation. In this way, the hearing-impaired user 900 may be able to comprehend what the intended sound source 901 says via the visual information displayed by the display device 6.

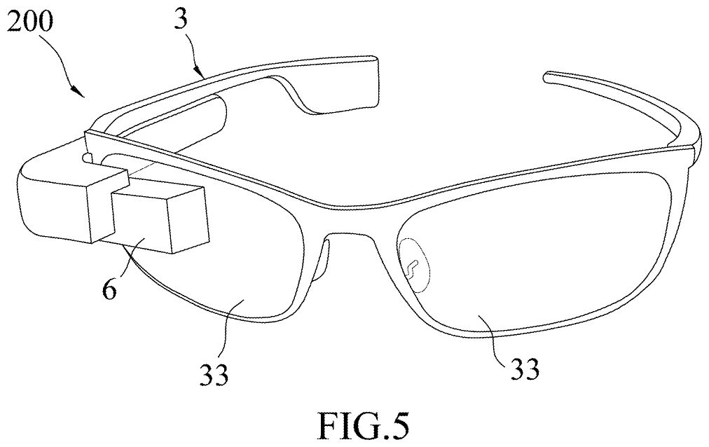

Referring to FIG. 5, in one embodiment, the display device 6 is a micro-projector mounted on the carrier 3, and is configured to project the visual information and the FOV image on at least one of the lenses 33 of the carrier 3 based on techniques of micro-projection. The hearing-impaired user 900 may make a selection of a selected area in the FOV image thus projected by means of visual control or an input device (not shown) of the communication aid system 200.

In one embodiment, the display device 6 is a see-through display and is mounted on the carrier 3. The display device 6 is adapted to be positioned in front of the eyes of the hearing-impaired user 900. Like the embodiment with the micro-projector, the hearing-impaired user 900 may select a selected area of the FOV image thus projected by means of visual control or an input device (not shown) of the communication aid system 200.

In summary, when operating in one of the sound receiving modes, the communication aid system 200 according to the disclosure controls corresponding preset one(s) of the microphones 41 to receive sound to generate collected audio signal(s), and performs audio signal processing specific to such sound receiving mode on the collected audio signal(s) to result in a processed audio signal. Thereafter, using speech recognition techniques, the communication aid system 200 is able to recognize speech information contained in the processed audio signal, and converts the same into visual information (e.g., texts or images) to be displayed by the display device 6. The communication aid system 200 according to the disclosure is thus an alternative to conventional hearing aid devices for hearing-impaired individuals. Moreover, the communication aid system 200 according to the disclosure allows a hearing-impaired user 900 to designate sound which he/she intends to receive specically. In this aspect, the communication aid system 200 is operable to receive sound coming from a designated position that corresponds to an area selected by the hearing-impaired user 900 in the FOV image displayed by the display device 6, and to convert recognized speech information in the received sound into visual information for viewing by the hearing-impaired user 900. Therefore, communication between the hearing-impaired user 900 and other people is facilitated.

In the description above, for the purposes of explanation, numerous specific details have been set forth in order to provide a thorough understanding of the embodiment. It will be apparent, however, to one skilled in the art, that one or more other embodiments may be practiced without some of these specific details.

It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A communication aid system for assisting a hearing-impaired user, said communication aid system comprising:
a sound receiving device including
a plurality of microphones that are spaced apart from each other, and
a sound receiving controller that is communicably connected with said microphones, that is switchable among a plurality of sound receiving modes, and that is configured to, for each of the sound receiving modes, when said sound receiving controller operates in the sound receiving mode, control a corresponding subset of said microphones to receive sound to generate one or more collected audio signals, and perform audio signal processing specific to the sound receiving mode on the collected audio signal(s) so as to generate a corresponding processed audio signal; and
a display device communicably connected with said sound receiving device, and including
an audio-to-visual converter that is configured to receive the processed audio signal, and perform speech recognition on the processed audio signal so as to recognize speech information contained in the processed audio signal, and convert the speech information thus recognized into visual information, and
a display that is communicably connected with said audio-to-visual converter, and that is configured to display the visual information.

2. The communication aid system as claimed in claim 1, wherein the plurality of sound receiving modes include an omnidirectional mode and at least one directional mode, said sound receiving controller including:
a microphone control module that is switchable to the omnidirectional mode where said microphone control module controls one of said microphones to receive sound to generate a collected audio signal and performs audio signal processing specific to the omnidirectional mode on the collected audio signal to generate a corresponding processed audio signal, and is switchable to the at least one directional mode where said microphone control module controls two of said microphones to receive sound to generate collected audio signals; and
a speech detecting module that is configured to
determine whether the processed audio signal generated by said microphone control module in the omnidirectional mode contains speech information, and
when it is determined that the processed audio signal contains speech information, control said microphone control module to switch to the at least one directional mode.

3. The communication aid system as claimed in claim wherein:
the at least one directional mode is plural in number, the directional modes respectively corresponding to different values of directivity index (DI); and
said speech detecting module is configured to control said microphone control module to switch to the directional modes one by one so as to obtain a processed audio signal having optimum signal-to-noise ratio among processed audio signals that would be generated respectively in the directional modes.

4. The communication aid system as claimed in claim 2, further comprising:
an image capturing device configured to capture a field of view (FOV) image which is an image of surroundings seen by the hearing-impaired user;
wherein said display device further includes a controller that is operable to control said display to display the FOV image in real time, to generate a direction designation signal that indicates a position of a selected area in the FOV image based on user input of selecting the selected area, and to output the direction designation signal to said sound receiving device; and
wherein the plurality of sound receiving modes further include a direction designation mode, and
wherein said microphone control module, in response to receipt of the direction designation signal, is switched to the direction designation mode, where said microphone control module is configured to control a predefined subset of said microphones each of which is at a predefined position to receive sound to generate collected audio signals, to perform, based on the direction designation signal, filtering processing on the collected audio signals by using beamforming techniques so as to generate a filtered audio signal which corresponds to sound corning from a direction that is related to the position of the selected area in the FOV image indicated by the direction designation signal, and to perform audio signal processing specific to the direction designation mode on the filtered audio signal to generate a corresponding processed audio signal.

5. The communication aid system as claimed in claim 4, further comprising a carrier to be worn on the hearing-impaired user, wherein said sound receiving device and said image capturing device are mounted on said carrier.

6. The communication aid system as claimed in claim 5, wherein:
said carrier is a pair of glasses that has a lens to be positioned in front of an eye of the hearing-impaired user; and
said display device is mounted on said carrier, and is configured to project the visual information and the FOV image on said lens of said carrier based on techniques of micro-projection.

7. The communication aid system as claimed in claim 5, wherein:
said carrier is a pair of glasses; and
said display device is a see-through display, is mounted on said carrier, and is to be positioned in front of an eye of the hearing-impaired user.
